(19) United States
(12) Patent Application Publication
(10) Pub. No.: US 2010/0004024 A1
(43) Pub. Date: Jan. 7, 2010

(54) COMMUNICATION DEVICE WITH MUTING FUNCTION AND METHOD THEREFORE

(75) Inventor: Dan-Feng Wu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/436,931

(22) Filed: May 7, 2009

(30) Foreign Application Priority Data
Jul. 4, 2008 (CN) 200810302526.X

(51) Int. Cl. H04B 1/38; G08B 1/00; G06F 3/041

(52) U.S. Cl. 455/565; 340/309.8; 345/173; 455/566

(57) ABSTRACT

A portable communication device includes a user interface responsive to user input, a controller, and a time management module coupled to the controller. A schedule tabled is created in accordance with the user input. The time management module periodically checks the schedule table and sends real time signals to the controller. The controller enables and disables the function in accordance with the schedule table. A method for enabling or disabling the functions of the communication device is also disclosed.

### BACKGROUND

1. Technical Field

The present disclosure relates to consumer electronics, and particularly relates to an electronic device having muting capabilities.

2. Description of Related Art

Many electronic devices include alert functions that can be muted. Examples include cell phones, personal digital assistants (PDAs) and gaming devices. In the case of cell phones, for instance, one type of alert function is an incoming call signal. An alert of the incoming call signal can be either an audible ringer or a vibrational ringer. Many cell phones allow the user to switch between the audible ringer and the vibrational ringer. Another alert function that is common amongst electronic devices is a calendared event reminder that activates the alert upon the calendared event. Another common alert function is a count-down timer that triggers the alert after a predetermined time has elapsed.

Typically, electronic devices allow the audible alerts to be muted because such alerts may not be appropriate in some environments. Thus, users commonly mute their electronic devices upon entering meetings, theaters, courtrooms, and so forth. However, users may forget to unmute the electronic devices, thereby missing important calls or messages.

Therefore, what is needed is a way to automatically enable the mute function or alert functions as scheduled.

### BRIEF DESCRIPTION OF THE DRAWINGS

FIG. 1 is a block diagram of an embodiment of a communication device with muting function; and

FIG. 2 is an operational flow diagram illustrating an operational sequence of the communication device of FIG. 1, according to an embodiment.

### DETAILED DESCRIPTION OF THE EMBODIMENTS

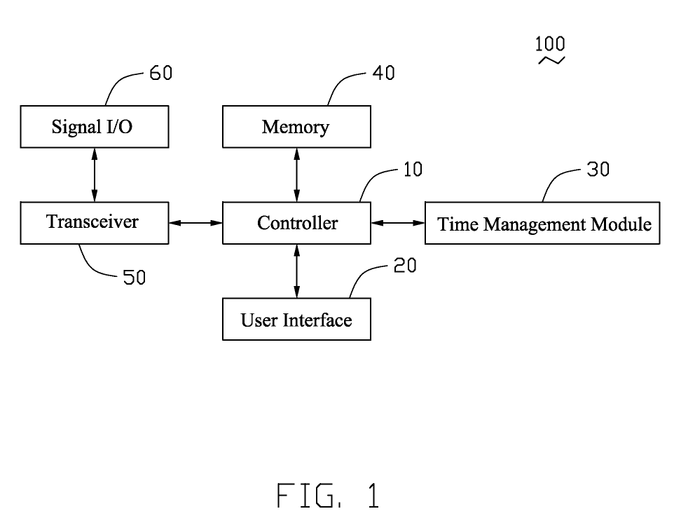

Referring to FIG. 1, an embodiment of a communication device 100 includes a controller 10, a user interface 20, a time management module 30, a memory 40 for storing programs and data, a transceiver 50, and a signal input/output (I/O) 60 coupled to the transceiver 50. The transceiver 50 transmits or receives signals via the signal I/O 60.

The controller 10 utilizes signal processing techniques for processing signals received from the user interface 20, the time management module 30, the transceiver 50 of the communication device 100. The controller 10 further sends commands to the user interface 20, the time management module 30, the memory 40, and the transceiver 50.

The controller 10 is communicatively coupled to the user interface 20 for receiving activation signals from the user interface 20 and sending signals to the user interface 20 which shows corresponding information thereon. When an activation of the user interface 10 by a first user input for enabling a muting function is detected, a schedule table is stored. The controller 10 comprises an automatic scheduler which activates and deactivates the muting function according to the schedule table. For example, a user of the communication device usually has a meeting or a class starting from 9:00 to 11:00 am. every work day (i.e. Monday to Friday), the muting function is set to be activated from 9:00 to 11:00 am, Monday to Friday.

Additionally, there is a call resistance function. When an activation of the user interface 10 by a second user input for enabling a call resistance function is detected, the communication device 100 is capable of rejecting unwelcome incoming calls by a manner of sending busy signals, sending text messages to the callers, and sending the call to voicemail. For example, if a user of the communication device 100 has to keep the communication device 100 power on all the day for important calls, but does not want to be interrupted by other inessential calls during usual sleep time, the call resistance function may be set to be activated to reject the unwelcome calls during a period of sleep time entered by the user.

The user interface 20 can be a combination of an input unit (such as a group of keys or buttons) and a display unit for display corresponding information thereon, such as a plurality of user-selectable choices thereon. The user interface 20 can also be a touch screen having both input and display functions.

The time management module 30 is coupled to the controller 10 and periodically checks the schedule table. If it's time to mute the communication device 100, the time management block 30 sends a signal to the controller 10, then the controller 10 sends commands to mute the communication device 100.

In one embodiment, the communication device is a cell phone. The user can set the muting function and the call resistance function to be activated at desired times.

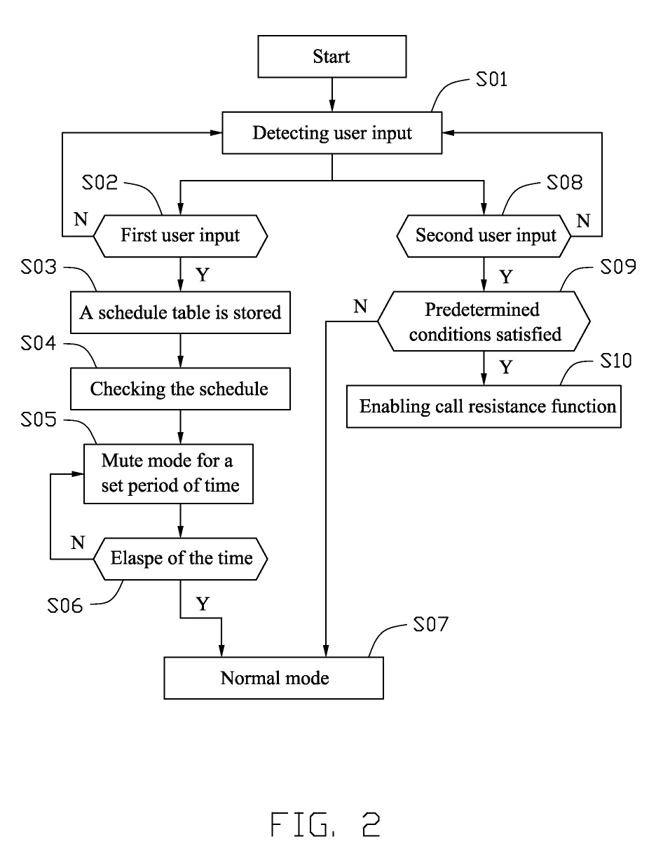

Referring to FIG. 2, an operational sequence, according to one embodiment of the communication device 100, includes the following blocks.

In block S01, an activation of a user interface by the user input is detected. In block S02, the first user input for enabling muting function is detected. In a block S03, a schedule table is stored in the memory 40 of the communication device 100 according to the first user input for activation/deactivation of the muting function. In block S04, the time management module 30 checks the schedule table periodically and sends real time signals to the controller 10; the scheduler of the controller 10 is executed to activate or deactivate the muting function according to the schedule table. In block S05, the communication device 100 is in a mute mode for a set period of time specified in the schedule table. In block S06, the set period of time elapses. In block S07, the mute function is removed, the communication device 100 is in a normal mode which notifies the user for calls and messages using audible ring, vibration, audible vibration, screen illumination, and etc.

In block S08, the second user input for enabling the call resistance function is detected. In block S09, predetermined conditions of the call resistance function are satisfied. The predetermined conditions include incoming calls of unwelcome callers, inessential incoming calls, and/or a time period (i.e. sleeping/resting time). In block S10, the call resistance function is enabled if the predetermined conditions are satisfied.

In the embodiment, the schedule table is created after the first user input for enabling the muting function is detected. The schedule table contains codes of the muting function and time events for enabling or disabling the muting function. However, in other embodiments, the schedule table contains codes of the muting function and the call resistance functions and any other functions related to time events.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

1. A portable communication device comprising:
a user interface responsive to user input;
a schedule table containing at least a time event and at least one function enabled or disabled when the time event is satisfied in accordance with the user input;
a controller, communicatively coupled to the user interface; and
a time management module coupled to the controller, for periodically checking the schedule table and sending real time signals to the controller for enabling and disabling the function in accordance with the schedule table.

2. The portable communication device of claim 1, wherein the user interface provides user-selectable choices.

3. The portable communication device of claim 2, wherein the user interface is a touch screen.

4. The portable communication device of claim 2, wherein the user interface comprises a display unit to display the user-selectable choices thereon and an input unit.

5. The portable communication device of claim 1, wherein the function is a muting function which is automatically enabled for a set period of time.

6. The portable communication device of claim 1, wherein the muting function is removed after an expiration of the set period of time.

7. The portable communication device of claim 1, wherein the function is a call resistance function which is set to be enabled at for a set period of time.

8. The portable communication device of claim 7, wherein incoming calls are do not cause the phone to alert the user when the call resistance function is enabled.

9. The portable communication device of claim 1, wherein the portable communication device is a cell phone.

10. A method comprising:
providing a communication device;
detecting an activation of a user interface by a user input;
in responsive to the user input, storing a schedule table specifying at least a time event to enable or disable the muting function, enabling or disabling a call resistance function of the communication device, or both enable or disabling the muting function and enabling or disabling a call resistance function of the communication device.

11. The method of claim 10, further comprising periodically checking the schedule table and timely sending real time signals to a controller of the communication device.

12. The method of claim 10, wherein the muting function is automatically enabled for a set period of time specified in the schedule table.

13. The method of claim 12, further comprising removing the muting function of the communication device after an expiration of the set period of time.

14. The method of claim 10, wherein the call resistance function is enabled when a predetermined condition is satisfied.

15. The method of claim 14, wherein the predetermined condition is an incoming call of an unwelcome caller certain times set by the user.

16. The method of claim 10, wherein unwelcome incoming calls are rejected during the call resistance function is enabled.
